(19) United States
(12) Patent Application Publication
(10) Pub. No.: US 2013/0118173 A1
(43) Pub. Date: May 16, 2013

(54) AIRBORNE ENERGY GENERATION AND DISTRIBUTION

(71) Applicant: Paulo Alexandre Cardoso, Lisboa (PT)

(72) Inventor: Paulo Alexandre Cardoso, Lisboa (PT)

(21) Appl. No.: 13/697,329

(22) PCT Filed: May 10, 2011
(86) PCT No.: PCT/PT2011/000015

§ 371 Date: Jan. 29, 2013

(30) Foreign Application Priority Data
May 10, 2010 (PT) 105112

(51) Int. Cl. F03D 5/00

(52) U.S. Cl. CPC F03D 5/00
USPC 60/698

(57) ABSTRACT

The present invention proposes a process involving the use of at least one, preferentially several non-tethered airships of at least one type, at least carrying one solar energy unit (SEU) and/or one wind energy unit (WEU) for carrying out certain airborne missions of generating a given total amount of final energy (E), whereby preferentially most of which (E1) is used for energy distribution, including airborne energy transmission by means of onboard energy transmission units (ETU), and/or storage by means of onboard, energy storage units (ESO) and supply thereof by connecting to energy devices or grids at platforms (A) or consumers (B), and whereby at least most of the remanding energy amount (E2=E−E1) is used for direct uses by said airships, such as flight assistance systems, or for other uses, such as telecommunications; The present invention also proposes distinctive features of said airships, respective platforms and energy systems associated with, different missions of airborne energy generation and distribution.

### CROSS-REFERENCES TO RELATED APPLICATIONS

This is a U.S. national phase application of PCT/PT2011/000015, filed May 10, 2011, which claims priority to Portugal 105112, filed May 10, 2010, both of which are incorporated by reference in its entirety.

### TECHNICAL FIELD OF THE INVENTION

The present invention refers to a process of using airships for energy generation and distribution. Moreover it refers to airships, respective energy systems and infrastructures for carrying out such a process.

### BACKGROUND OF THE INVENTION

Different ways have been proposed of using airships to carry different types of wind energy devices at high altitudes, notably by means of tethered devices, in isolation (e.g., U.S. Pat. No. 4,450,364), or in tandem (e.g., U.S. Pat. No. 7,129,596 B2). The operation of tethered kites and airships constantly requires a comparatively big airspace volume, for a given energy capacity level. Moreover, depending on the actual technology and altitude range, such tethered wind energy devices do not exclude the need for propulsion means or interruption of operations under adverse weather. On the other hand, all these systems follow a supply-centric model, whereby all generated energy is transmitted (via the tethering cable) to one, eventually remote location for further grid distribution, therefore being difficult to apply to demand-driven applications, mobile energy users and respective locations.

There have also been proposals for combining different forms of energy storage, in general, and of compressed air, in particular, with wind energy generation, in general, and with airborne energy generation in particular. The U.S. Pat. No. 4,431,739 discloses a tethered airship carrying one wind turbine and including compressed air energy storage meant for powering the airship during periods of lower wind velocity. The U.S. Pat. No. 5,518,205 and the U.S. Pat. No. 6,607,163 disclose autonomous airships using solar panels and generic onboard storage means. In all such cases, the inherent processes—flight missions—and devices aeronautic and energy are designed for meeting respective airship energy requirements in view of extending airborne periods.

The aforementioned solutions are therefore based upon the maximization of airborne energy generation and distribution individually by each airship to a given localization, whereby a respective group thereof occupies a substantial airspace volume. This represents a significant constraint.

The US 2009/0072078 A1 discloses an airship for missions of long flight periods at very high altitude and that, besides of the solar and thermal energy generation, transmits this energy remotely, without using wires, to a plurality of other air vehicles. This solution does not therefore correspond to a maximization of the capacity for energy generation and distribution by a plurality of airships and respective distribution to a location within a given region.

None of the solutions disclosed in the prior art solves the problem of minimizing the volume of airspace occupied by a plurality of air vehicles, in particular of the airship type, in parallel with the maximization of energy generation and distribution to a given location.

### SUMMARY OF THE INVENTION

The present invention addresses the problem of organizing operations of airships and energy systems, i.e. airborne and ground processes, evolution in time, control structure, key design aspects of devices and installations involved in such processes, in such ways and scales that airborne renewable energy generation and distribution becomes of economical advantage across different prospective applications, while at minimal environmental impacts (land and airspace use, visual and noise impacts, wildlife and public health hazards).

The present invention solves the aforementioned problem by means of a process that maximizes airborne energy generation and distribution capacity per dimension and time scales of respective means (e.g., groups of airships, respective energy generation and distribution systems), at maximal energy use value (different energy forms, respective airborne generation, transmission and storage possibilities, modular energy generation and distribution processes, different locations and final energy uses), as illustrated by preferred embodiments of said process disclosed hereunder.

The process according to the present invention involves the use of at least one, preferentially several non-tethered airships comprising at least one renewable energy device generating a given total amount of energy (E) during the flight between an initial altitude level and a destination altitude level and back to said initial altitude level, whereby part (E1) of that energy is used for distribution by said at least one, preferentially several airships to at least one respective platform and/or consumer. Said energy distribution to at least one platform and/or consumer is carried out by said airships by means of airborne energy transmission by onboard energy transmission units (ETUs) and/or by means of temporary energy storage on onboard energy storage units (ESU) and delivering this energy to said platforms and/or consumers. The remanding energy amount (approximately E2=E−E1) is used directly by said airships, such as for flight propulsion and assistance systems, and eventually other uses, such as remote data acquisition, data processing and telecommunications.

Such process, (mission) preferentially corresponds to cycles of operations whereby said airships go airborne at a given moment and up to certain altitude levels, thereby generating wind and/or solar energy during the flight by means of respective wind energy units (WEU) and or solar energy units (SEU), and transmitting preferentially most of it (E1) by means of said ETUs, and/or storing it by means of said ESUs until reaching a given relative load thereof, and thereafter flying back to respective platforms and/or energy consumers for connecting said ESUs to respective energy conversion devices and/or energy distribution grids.

This unfolds according to a substantially supply-centric energy distribution model that provides a given capacity at a given location for further distribution to consumers, or, alternatively, according to a substantially demand-centric energy distribution model whereby energy transmitted by said ETUs or stored in said ESUs, is directly delivered to end-consumers or to areas of high energy demand concentration at respective locations and as required by the latter.

Such process also corresponds to said airships going airborne according to weather conditions and/or time of day, thereby generating energy while such conditions are favorable, and immediately transmitting at least most of it by means of said ETUs to respective platforms and/or consumers while further airborne.

Such process also corresponds to said airships hovering for long periods at relatively high altitudes, thereby substantially continuously generating energy and providing it to ESUs onboard other airships of a different type that shuttle between the latter and a respective destination.

As a preferred embodiment of the process according to the present invention, groups of airships operate in coordinated fashion, along preferentially continuously repeated cycles of operations, whereby at any given instant and/or for a given period, several airships offload respectively airborne stored energy to a respective platform. More preferentially, there is a given value of power capacity being supplied at any moment by a plurality of airships at a respective platform.

As another preferred embodiment, the distributed energy is in the form , of a high-pressure fluid (e.g., air), fluid fuel (e.g., hydrogen) and/or electricity.

The process according to the present invention thereby maximizes flight energy efficiency, so that highly scalable capacities of different renewable energy forms can be generated and distributed across different geographical distribution reaches and patterns of energy demand, at lowest energy transmission costs and best dispatch conditions. Certain embodiments of the process may be combined with urban, areas or highly frequented routes (in both cases places of high energy demand concentration).

Moreover, the present invention also proposes key design aspects of airships and—respective platforms for carrying out said process.

### DETAILED DESCRIPTION OF THE INVENTION

According to a first inventive aspect of the present invention, it is a process for airborne energy generation and distribution, including at least one airship of at least one type, comprising at least one lift element and at least one renewable energy device and at least one energy transmission unit and/or at least one energy storage unit, whereby said airships carry out at least one cycle of operations including flying a trajectory from an initial altitude level to at least one destination altitude level and back to said initial altitude level, thereby generating a total amount of energy (Eₐᵢᵣ) by means of said renewable energy devices and/or distributing part (E1) of said total energy (Eₐᵢᵣ) by means of said energy transmission unit and/or by means of said energy storage unit, to at least one platform and/or energy consumer in a given region.

According to another inventive aspect, it is a process whereby said cycle of operations starts when a first airship leaves from a platform and/or starts distributing said distribution energy (E1), and ends when said first airship or a last airship next arrives at a platform and/or has finished distributing said distribution energy (E1). And according to another inventive aspect, it is a process whereby said cycle of operations starts, not long after conclusion of the previous one and/or starts at least once and/or lasts within a local daytime, period and/or nighttime period, as long as flight conditions remain favorable at and/or between said altitude levels (H0, H1).

Thus, in a preferred embodiment it is a process whereby said airships, preferentially operating in groups of several airships, carry out several substantially successive cycles of operations. In certain embodiments, this translates into a substantially continuous “carrousel”, whereby airships start a cycle after concluding a previous one, thereby commuting between one altitude level (e.g., H1) and another (e.g.,), thus maximizing the total amount of energy distribution. In another preferred embodiment, these cycles are substantially adjusted to happen during the local daytime or nighttime periods, notably in view of the availability of primary energy, e.g., solar radiation, or of visibility aspects. In this case, a group of airships for example leaves a platform at early daylight and returns before nighttime.

According to another inventive aspect, it is a process whereby for the longest part of said cycle of operations said airships are and/or generate most of said distribution energy (E1) while approximately at or above said destination altitude level (H1, . . . ), or while flying between said altitude levels (H1, . . . ). In a preferred embodiment, airships generate most of said distribution energy while hovering at a given altitude range (e.g., H1), thereby using the most of an airspace area having incident solar radiation and the least volume of airspace. In a preferred embodiment, a group of airships commutes between two altitude levels, thereby using the balance of the ascension force and upstream wind to generate energy (Eₐᵢᵣ), a given part of which (E1) is thereby stored onboard for later distribution.

According to another inventive aspect, it is a process whereby for at least one period during said cycle of operations, a plurality of said airships is generating and/or distributing energy at any of said altitude levels (H0, H1, . . . ).

According to another inventive aspect, it is a process whereby said airships distribute at least most of said distribution energy (E1) while approximately at or above said, destination altitude level (H1) and/or while at or above said initial altitude level (H0).

According to another inventive aspect, it is a process whereby in at least one of said cycle of operations several said airships distribute at least partially simultaneously, respective distribution energy (E1) to a common platform. In certain embodiments, this translates into a plurality of airships distributing energy (E1) at the same time, and thus making a bigger energy delivery capacity available at said platform and points to certain preferred embodiments of airships and platforms in view of exploring such potential—as further described hereunder in relation to preferred embodiments.

According to another inventive aspect, it is a process whereby in at least one of said cycle of operations at least one airship distributes energy (E1) via at least one other, eventually different airship, across said altitude levels. In certain embodiments, this translates into a reduced amount of airspace required for transmitting said total energy (E1)×n, as generated and made available by a group of n airships at a given altitude level (e.g. H1), to a respective energy destination at another altitude level (e.g. , H0). According to another inventive aspect, it is a process whereby at least one airship, preferentially several said airships, provide respective—distribution energy (E1) to and/or while in the proximity or stationed at a platform.

According to another inventive aspect, it is a process whereby said destination altitude level and/or said flight trajectory of said airships between any successive altitude levels or two successive platforms and/or energy consumers, are determined by onboard and/or external information and communication means at least as a function of prevailing flight conditions, and in view of maximizing said distribution energy (E1) and minimizing the energy (E2) and volume of airspace required by said airships within a given region.

According to another inventive aspect, it is a process whereby each airship at preferentially very frequent moments coordinates respective cycles of operations with at least one other, preferentially directly precedent or following airship and/or platform in a same process, notably in view of the energy demand at a platform and/or energy consumer and respective geographic distribution, by sharing at least respective geo-positions and/or weather and flight conditions at respective locations and/or evolution of respective energy generation and distribution operations.

According to the present invention, there could thus be different embodiments regarding the profile of missions in time, notably relating to the repetition pattern of cycles of airborne and ground operations, to the type of trajectories to be followed and to the conditions determining start and duration thereof

In this respect, according to a first embodiment, said airships remain airborne for substantially long periods (tₕ) mostly hovering above said destination altitude level, thereby carrying out multiple successive operations of energy generation and distribution of said energy (E1) to other airships, for the purpose of these storing energy in respective storage energy units, that continuously shuttle between the latter and respective platforms.

In another embodiment according to the invention, airships follow substantially vertical flight trajectories starting from an initial, for example ground level, thereby ascending and descending along preferentially narrow airspace volumes, at least until reaching a said altitude level, then hovering in preferentially substantially stationary geo-positions within a substantially narrow altitude range preferentially above said destination altitude level, or moving along preferentially pre-determined enclosed trajectories, preferentially within an imaginary airspace cylinder above respective platforms, and/or moving along preferentially predetermined, more preferentially in closed loops along certain extensions, proximal to the trajectories frequently used by ships in long sea routs and/or by airplanes in average long and transcontinental flight routes, and being approached by a respective energy consumer as required by the latter.

According to another embodiment, airships start said airborne operations at regular or irregular season, day and/or time of day schedules (tₐ) and during regular or irregular airborne periods (tₐᵢᵣ), notably as a function of forecasted and/or prevailing weather conditions in the airspace to be covered by airborne operations and/or of forecasted and/or prevailing energy demand (D) by a respective energy network or consumer, at the end of which they carry out ground operations (t_{b}).

According to another embodiment, airships carry out ground operations, notably while stationed at a respective platform during a given period (tₐ t_{b}) at and/or in the proximity of ground level, for providing airborne stored energy (E1) and/or for maintenance purposes, thereby preferentially not greatly exceeding respective energy provision period (t_{c}).

According to another embodiment, airships preferentially repeat several sequences of airborne (tₐ t_{b}) and ground operations (tₐ t_{b}) in preferentially substantially uninterrupted cycles.

Moreover, according to another embodiment, airships carry out said airborne operations at least partially simultaneously, so as to minimize duration of airborne period (tₐᵢᵣ.) notably in view of respective energy storage capacity (Lₘₐₓ).

Besides of aspects intrinsic to the cycles of operations, the present invention proposes a process for airborne energy generation and distribution including certain preferred forms of energy generation, by means of renewable energy devices, and distribution, notably by means of airborne energy transmission or by means of airborne energy storage.

In this respect, according to an inventive aspect, it is a process whereby transmission b a given airship of said distribution energy (E1), includes establishing an electric power connection and/or a electromagnetic connection between respective said energy transmission unit and a respective energy receiver unit.

Moreover, onboard energy storage should also play an important role in prospective embodiments of the process according to the invention. In this respect, according to an. inventive aspect, it is a process whereby energy storage by a give airship of said distribution energy (E1), includes carrying out a substantial change of pressure and/or temperature in at least one working fluid and/or thermal storage medium, eventually with change of respective state and/or composition, and/or change of electrochemical parameters and/or electromagnetic state of a medium, contained in a respective said energy storage unit.

According to another preferred embodiment, it is a process whereby the provision of said distribution energy (E1) stored airborne by a given airship, includes the operations of mechanically and/or magnetically and/or electrically connecting/disconnecting respective energy storage unit to respective energy conversion and/or distribution means connected to at least one energy network or in an energy consumer, and. providing said distribution energy (E1) via such connection, or cargo loading/offloading said energy storage unit.

According to another preferred, embodiment, it is a process whereby mechanical connection by a given airship at a respective platform at least includes a preferentially high-pressure fluid connection between said energy storage units and respective energy conversion and/or distribution means.

An alternative process according to the invention, proposes using the energy being generated airborne to process a primary energy fluid, such as for example water, into an energy fluid, such as for example hydrogen, thereby storing these in respective compartments onboard respective airships. In this respect, according to another preferred inventive aspect, it is a process whereby airborne energy generation and distribution includes uploading a primary energy fluid and/or substance to said airship while airborne and/or stationed at a. respective platform, preferentially to respective ballast means, and or direct processing thereof and storing the thereby resulting final energy fluid into respective energy storage unit, preferentially while airborne.

Besides of the key aspects of the airborne energy generation and distribution process, the present invention also advances preferred energy systems involved in such process.

According to the invention, it is proposed to have at least the compression part of a compressed air system onboard each airship, operating as airborne energy storage solution, and the expansion part in a respective platform and/or energy consumer. In this sense, said storage and provision by a given airship includes driving at least one, preferentially several cascaded, mechanically driven, or electrically driven onboard compressor (s) for high, preferentially very high pressure compression of a compressible fluid into respective said high pressure reservoirs and expanding said high pressure compressible fluid, by means of respective expansion devices disposed at a respective platform and preferentially connected to power generators, fluid fuel engines, gas turbines, or alternative devices, that provide a given electrical power to a respective power grid. In a preferred embodiment, said compressible fluid is preferentially ambient air, preferentially at high relative humidity levels, or another fluid.

Moreover, in a preferred application possibility and in order to improve the overall efficiency of the airborne energy storage, said high pressure compressible fluid in said energy storage units is preheated before expansion in respective expansion devices, thereby preferentially using low-grade heat sources such as geothermal or solar installations, residual heat from industrial processes, condensing air in thermal power plants, preferentially available at or in the proximity of a respective platform.

According to the invention, it is proposed to have a thermal compression system associated with the ballast means, operating complimentary to the thermal compression system associated with airborne energy storage. In this sense, at least part of total airborne generated energy (Eₐᵢᵣ) is used for high pressure compression of a, eventually different, compressible fluid into respective lift and/or ballast means, whereby the heating power resulting from such compression is used, preferentially by means of a thermal fluid circulated as heat exchange medium, for preheating the high pressure working fluid contained in energy storage units preferentially before expansion in respective expansion devices disposed at a respective platform, and the cooling power resulting from expanding such working fluid from said lift and/or ballast means is used for reducing the temperature increase of the working fluid being compressed into said energy storage units.

Moreover, said thermal fluid is preferentially water, more preferentially a fluid of higher specific heat capacity, preferentially hydraulically circulated, in a closed circuit onboard said airship.

In view of maximizing the overall energy efficiency, the heating power resulting from high pressure compression of said compressible fluid into said units is used to significantly increase the temperature of a heat storage medium, inside a thermally isolated reservoir, such storage medium in turn driving a heat pump device for generating electrical power delivered to a respective grid, or energy consumer.

According to another application of the process according to the invention, the energy generated airborne may be used airborne to process a given fluid, such as water, or substance, such as a carbon compound, in view of, obtaining another, fuel-like composition. Thus, in a preferred solution of the process according to the invention, part of total energy (Eₐᵢᵣ) airborne generated by a given airship is used, preferentially while airborne, for driving an onboard device for processing a given primary energy fluid and/or substance into a final energy fluid that may be used to drive an energy system. In such case said primary energy fluid is preferentially water or water vapor, respective final energy fluid being hydrogen, or said primary energy fluid or substance is a composition, including carbon, such as carbon dioxide or other, respective final energy fluid preferentially being a hydrocarbon fuel.

In a preferred embodiment, said primary energy fluid is preferentially stored in high-pressure reservoirs simultaneously working as ballast “means, and” respective final, energy fluid, is stored in high pressure reservoirs, preferentially working as additional lift means.

In a preferred embodiment of the process according to the invention, airships also generate energy (E_{grd}) by means of respective wind and/or solar energy units, while in the proximity or stationed at a respective platform.

In another embodiment of the process according to the invention, at least; a part (E2) of total energy (Eₐᵢᵣ+E_{grd}) generated by said airship, is used for driving auxiliary end-uses of respective airborne energy generation and distribution operations, such as respective lift assistance and/or propulsion and/or ballast means, and/or control, sensor and telecommunication means, whereby at least part of such energy (E2) may also be stored, preferentially in auxiliary. energy storage units. Moreover, said energy (E2) for direct uses by the airship is preferentially mostly generated during airborne operations (Eₐᵢᵣ).

Thus, in a preferred embodiment, airships preferentially do not require additional energy sources for respective operations, besides onboard wind energy units and solar energy units.

According to another inventive aspect, the airborne energy storage method is designed in view of synergies with relevant flight means. In, fact, dynamic regulation of overall payload and weight balance, as determined by the lift, ballast and, in some cases, the onboard energy storage means, represents an important aspect of the overall energy efficiency of the process according to the invention. In this sense, it is proposed that onboard lift assistance means regulate the temperature inside lift elements and or of energy storage units, notably as a function of altitude of said airship and storage: load level (Lᵢ) of respective energy storage units at each moment.

According to another inventive aspect, the airborne energy storage method , is also designed in view of enhancing the energy deliver conditions, including power dispatch conditions, at a respective platform and/or energy consumer.

In this: sense, according to a preferred, embodiment (mission) of the airborne energy storage method in particular, energy storage units complete a full load cycle (Lₘᵢₙ−Lₘₐₓ) during one sequence of airborne (tₐᵢᵣ) and. ground (t_{grd}) operations, thereby preferentially being at minimum load (Lₘᵢₙ) when respective airships start airborne operations, begin being loaded preferentially after reaching a destination altitude level and being at preferentially maximum load (Lₘₐₓ) at the end of said airborne period (tₐᵢᵣ).

According to a different embodiment of the airborne energy storage method, said energy storage units complete several, at least partial, load cycles (L₁-L₂) while above said destination, altitude level.

In a still different embodiment of the airborne energy storage method, said airships cargo offload respective energy storage unit at preferentially full load (Lₘₐₓ)and cargo upload another such energy storage unit at preferentially minimum load (Lₘᵢₙ) as part of respective ground operations.

According to another embodiment, airborne energy generation and storage considers that said airships offload and/or upload a given amount of a gas or liquid from/into respective energy storage units and/or ballast means, by means of a preferentially highly flexible and extendable, preferentially high pressure connection, as part of respective airborne and/or ground operations.

As referred in the overall description of the first inventive aspect, airships for carrying out a process according to the present invention include at least one, preferentially several lift elements and at least one energy transmission unit and/or at least one energy storage units and/or at least one, preferentially several renewable energy devices, such as wind energy units and/or solar energy units.

These components are preferentially arranged symmetrically in relation to a central vertical and/or horizontal axis of said airship.

Said lift elements contain a lighter than air fluid, preferentially of varying quantity and/or pressure and/or temperature during respective, airborne operations (tₐᵢᵣ), and present a spherical, preferentially cylindrical, ovoid, oblate, toroidal form, or a combination thereof, made from a rigid, semi-rigid or flexible, preferentially high pressure resistant material or synthetic composition. Moreover, said lift elements are disposed completely, preferentially substantially above and/or completely, preferentially substantially around or in-between said energy storage units, and said ballast means are disposed substantially symmetrically relative to said energy storage units.

According to another preferred embodiment, airships also include aerodynamic elements of static and/or variable position and/or dimension and/or shape, i.e. are so-called hybrid airships, in view of best adjusting to prevailing flight conditions. This is an important aspect in view of minimizing the energy requirements of the airship, notably for propulsion, and thus maximizing the remanding distribution energy (E1).

In the case of airships mostly meant for wind energy generation, the central axis of each said wind energy unit is aligned with the central axis of a respective, at least one, power generator, and/or fluid compressor unit, thereby preferentially sharing a common driving axis.

Moreover, the central axis of said wind energy unit is preferentially aligned with the central axis of at least one said energy storage unit.

In the case of airships mostly meant for transmitting said distribution energy (E1), instead of storing it onboard, said energy transmission unit is preferentially a connection device for at least one electric conducting wire or cable, or similar element, more preferentially a wireless electromagnetic field or beam emitting device, for transmitting a given electrical power capacity between two locations, notably to a respective wire or cable connection device, or electromagnetic field or beam. receiving device, respectively.

In the case of airships carrying out airborne energy storage operations, said energy storage units and said ballast means are preferentially high pressure and/or high temperature, fluid and/or solid medium storage reservoirs, individually and/or collectively of substantially spherical, cylindrical or toroidal form, made from a preferentially rigid, more preferentially flexible, high pressure resistant, preferentially thermally insulated material or synthetic composition.

Moreover, according to a preferred embodiment, said energy storage units and said ballast means are inflatable and deflatable, thereby expanding from a respective minimal volume at minimal load (Lₘᵢₙ), up to a maximal volume at a maximal load (Lₘₐₓ), and vice-versa.

According, to another preferred embodiment, said lift elements and energy storage units and/or ballast means collectively have a spherical, preferentially cylindrical, ovoid, oblate, toroidal form, or a combination thereof, the lift elements thereby preferentially occupying the upper part of a respective volume, and the energy storage units and/or ballast means the lower part.

In particular, said energy storage units may include variable volume reservoirs for different fluids, whereby the heavier one is preferentially disposed on the lower part, and the lighter one on the upper part of said storage unit.

According to another preferred embodiment, said energy storage units are preferentially electrochemical and/or electromagnetic devices of preferentially rectangular, more preferentially substantially thin format.

In view of adjusting the lift provided by said lift elements to prevailing flight conditions, it is proposed the use of lift assistance mea s,' whereby said lift assistance means are preferentially in , the form of flat electric elements disposed preferentially in: wide area format over a substantial area of the lift elements, or of fluid circulating, elements with a similar disposition and transferring thereto heat resulting for example from an. onboard fluid compression process.

According to another preferred embodiment of the energy distribution process, said airship include means for assisting cargo offloading/ uploading of said energy storage units while stationed at a respective platform.

In this respect, it is herewith proposed as inventive aspect, that the energy generation and distribution process is carried out by airships of at least two different types, carrying different systems. Thus, in a preferred embodiment, some airships present substantially different configurations from other, whereby the latter, present means for proximity connection of at least two said airships.

Moreover, according to, the present invention, airships are substantially flight autonomous, so that said they further include propulsion means and substantially automatic control means, preferentially remotely assisted, more preferentially fully robotic, responsible for the avionic and energy generation and distribution operations, preferentially also the cargo handling functions applicable.

Besides of the different aspects relating to the processes involved and to airships carrying out such processes, it is a central aspect of the present invention to disclose platforms best suited for the processes according to the present invention.

Thus, according to a first inventive aspect, it is a process whereby said platform is a stationary construction or a mobile vehicle, including means for stationing and/or connecting of at least one airship; and energy reception and/or conversion and/or storage means connecting to at least one energy distribution grid and/or to at least, one energy consumer.

As a central inventive aspect according to the present invention, said platform is a construction or a vehicle, preferentially designed so as to allow stationing in the proximity or marooning of at least one airship. According to another inventive aspect, said platform includes a parallel circuit or “aorta-like” element for distribution of an electro-magnetic current, high pressure fluid or other energy form, from at least two, preferentially a plurality of airships at any given moment.

Moreover, said platform is a standalone construction, or part of another construction, such as a building. According to a preferred embodiment, said platform includes respective energy storage means and/or auxiliary energy conversion systems, for further providing energy, o consumers and/or to distribution grids connected thereto.

In this particular respect, in terms of energy distribution, said platform is thereby providing energy in an off-grid configuration, or as part of a. plurality of other energy generation sources. In the latter, case, as an example, it may built within urban areas, or in close proximity to, or part of thermal power plants or of wind parks.

### BRIEF DESCRIPTION OF THE DRAWINGS

All drawings are representations of schematic nature only of devices, structures and processes.

FIG. 1a-1c: first embodiment of a process for airborne energy generation and distribution;

FIG. 1d schematic diagrams of the key airborne energy processes, and time evolution of basic operations of said first embodiment;

FIG. 1e-1g: airships, and respective platforms for carrying out said first embodiment;

FIGS. 2a: a second embodiment of a process for airborne energy generation and distribution;

FIGS. 2b-2d: ground platforms for carrying out said second embodiment;

FIG. 2e: schematic diagrams of the key airborne energy processes and time evolution of basic operations of said second embodiment;

FIGS. 2f-2g: airships for carrying out said second embodiment;

FIGS. 3a-3b: a third embodiment of a process for airborne energy generation and distribution;

FIGS. 3c-3d: ground platform for carrying out said third embodiment;

FIG. 3e: airship for carrying out said third embodiment;

FIG. 3f: schematic diagram of combined airship energy storage and ballast means;

FIG. 3g: schematic diagrams of the key airborne energy processes and time evolution of basic operations of said third embodiment;

FIGS. 4a, 4d: a fourth embodiment of a process for airborne energy generation and distribution;

FIGS. 4b, 4c: airships for carrying out said fourth embodiment;

FIGS. 4e, 4f: particular airborne and ground operations of airships carrying out said fourth embodiment;

FIG. 4g: schematic diagrams of the key airborne energy processes and time evolution of basic operations of said fourth embodiment;

FIGS. 5a-5c: a fifth embodiment of a process for airborne energy generation and distribution;

FIGS. 5d: schematic diagrams of the key airborne energy processes and time evolution of basic operations of said fifth embodiment;

FIGS. 5e, 5f: airships for carrying out said fifth embodiment.

### DETAILED DESCRIPTION OF PREFERRED EMBODIMENTS

Hereinafter presented embodiments are illustrative examples only of processes according to the invention. Other combinations of features presented in each embodiment, are possible without leaving the scope of the present invention.

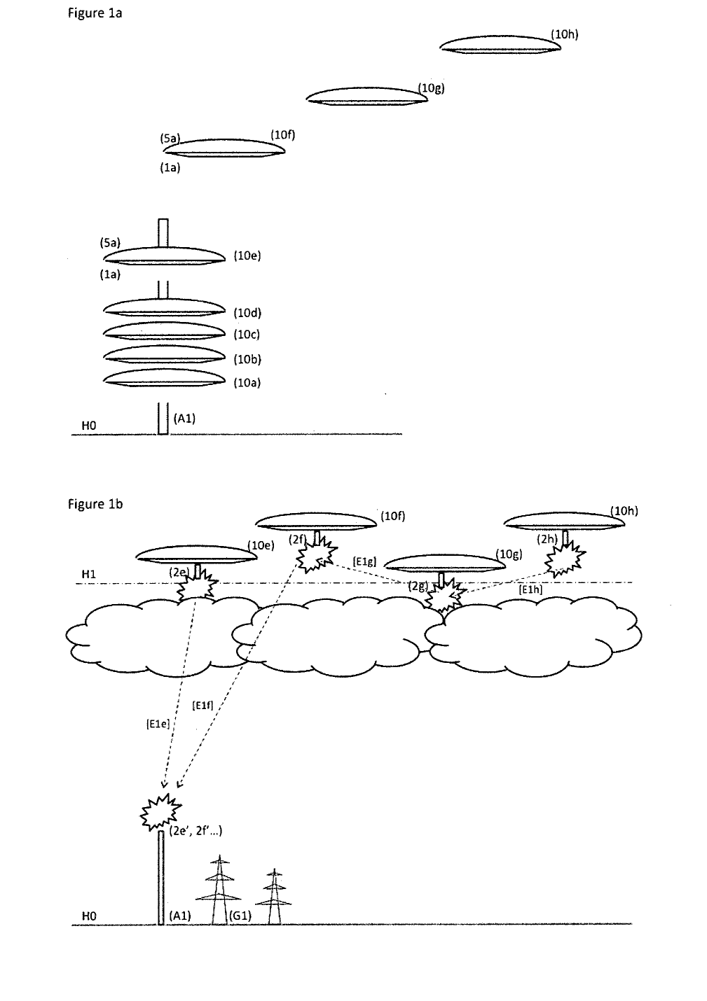

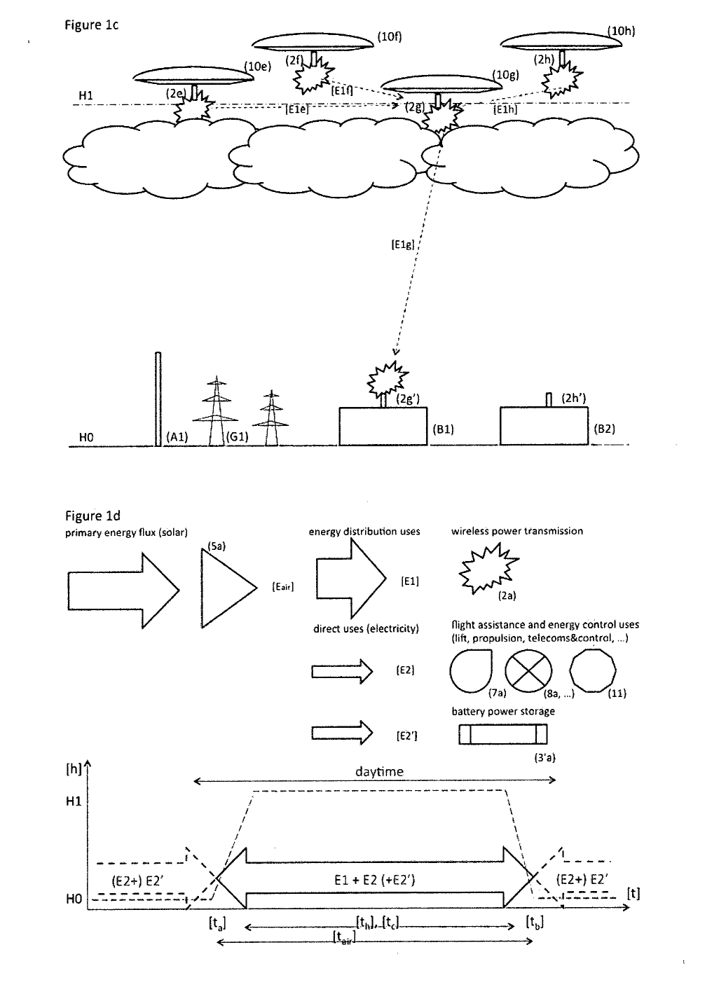

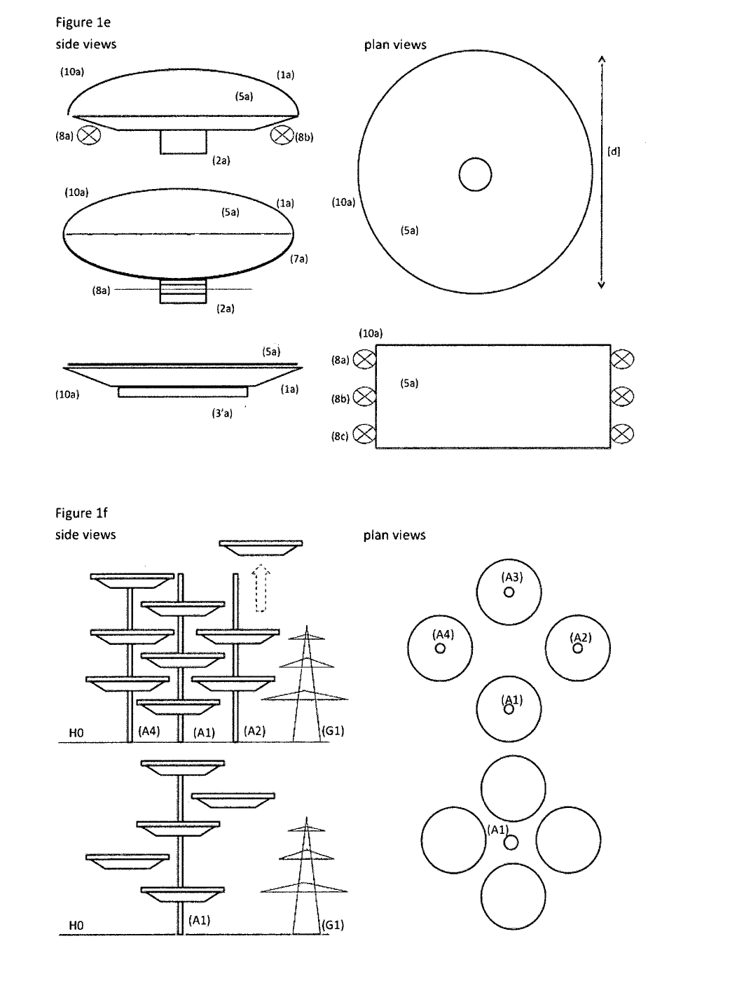

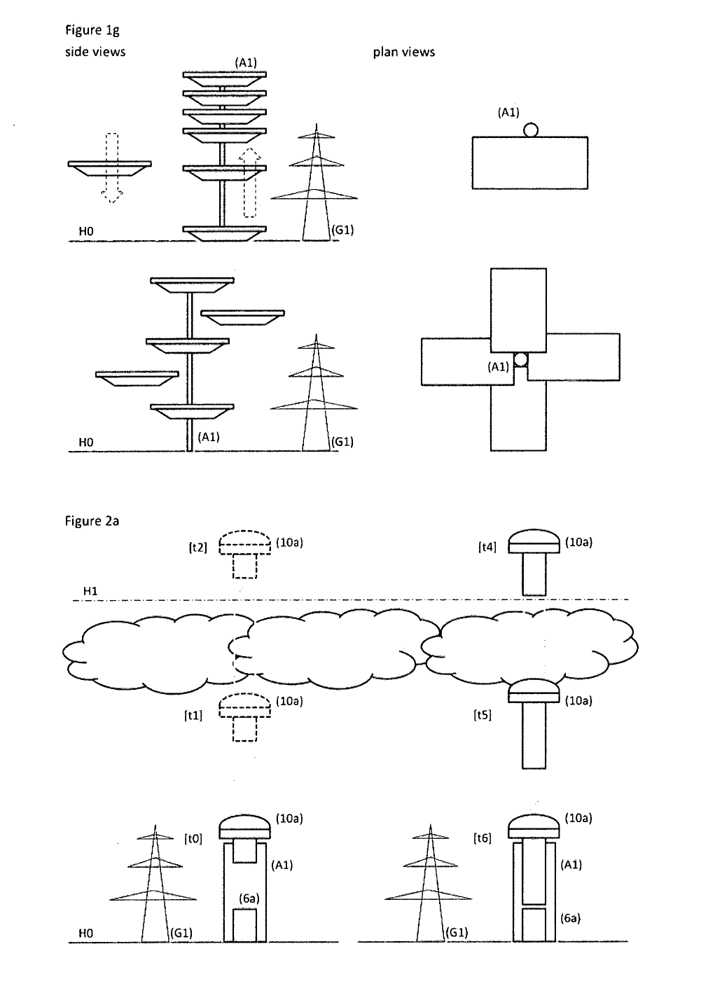

A first embodiment (see FIGS. 1a, 1b, 1c) corresponds to a process whereby several, preferentially similar airships (IQa, . . . ) go airborne up to a given altitude range (H1), generating and transmitting energy to a respective ground platform. (A1), or to several different receiving devices (B1, B2, . . . ) while hovering at such range (H1). These airships (10a, . . . ) include one lift element (1a), containing at least one lighter than air (LTA) fluid, one airship control unit (11)—not represented , and preferentially also airship propulsion (8a) and/or aerodynamic enhancing means not represented. Moreover, each airship (10a, . . . ) at least carries one solar energy unit SED—(5a), preferentially in the form of thin photovoltaic elements disposed at least over the upper surface of the lift element (1a), and one energy transmission unit ETU—(2a) and one auxiliary energy storage unit (3′a) for supporting onboard direct energy uses only. Alternatively, each airship (10a, . . . ) carries a solar radiation concentration device, such as a mirror, orienting thereby solar concentrated beam (E1) to a respective solar energy-device at a ground plat-form (A1).

A preferred process corresponds to having periods of airborne operation in at least certain days, as determined by weather conditions affecting flight and or airborne energy generation conditions. An example would be airborne operation only during reduced wind, cloudless weather conditions. Under such conditions, airships (10a, . . . ) go airborne up to a relatively low altitude, H1, of for example 200 m in cloudless days, or above 500 m low cloud formations in cloudy days, spreading themselves over a given area, and at least approximately hovering at said altitude level during the daytime period.

The basic energy processes and time evolution of basic operation parameters are depicted in two respective diagrams (see FIG. 1d). Solar radiation incident upon the SEU (5a) disposed over the superior surface of each airship (10a, . . . ) is converted by it (and respective auxiliary systems if required) , into a given total amount of electrical energy (E). Most part (E1) of such energy (E) is remotely transmitted by means of respective ETUs (2a, . . . ) to a respective receiver at the ground platform (A1). According to an inventive aspect, energy transmission occurs so that several airships transmit respectively generated energy at level H1, simultaneously to a respective platform (A1) disposed at another level, for example H0, thereby only using a comparatively reduced volume of airspace relatively to the disposition of airships. In this case, this is accomplished in such a way that several said airships transmit respective energy to one of them, so that the latter transmits further to said platform (A1), or alternatively, so that said transmission takes place in series, from one airship to an adjacent one, until being retransmitted to said platform (A1), or to several different individual receivers (B1 . . . )—FIGS. 1b, 1c. The remanding amount of power (E) is either immediately used (E2), or stored ([E2′) in a power storage device, such as an auxiliary battery (.3′a), for later use by onboard systems. One of these systems is an electric driven heating folio (7a), disposed on the inferior side of the lift element (1a) and providing additional lift as required. As depicted in the time diagram below, power (E) generation preferentially starts right after, airships (10a, . . . ) go airborne, and lasts at least until it docks back at respective ground structure (A1), whereas remote, transmission of power (E1) preferentially starts after reaching a respective altitude range H1 and lasts while the airship remains hovering within this range. Alternatively, power transmission only takes place when and in the amount as requested by respective receivers (B1, . . . ) during a given period of time, and generated power meant for supply uses (E1) is stored in an auxiliary battery (3a). These airships (10a, . . . ) may also carry radar, telecommunication, lighting systems and other.

The photovoltaic technology is preferentially of concentrated solar type, benefitting from enhanced heat dissipation by means of stronger altitude wind and lower air temperature. The energy transmission units (2a) are wireless electric and/or magnetic power transmission devices.

Airships (10a, . . . ) preferentially present (see Figure le) substantially circular, rectangular or polygonal plan-formats of low total construction height in relation to remanding overall dimensions, whereby the lift element (1a) preferentially represents most of the total respective volume. The lift element (1a) is preferentially made of a substantially transparent flexible material. After airborne operations, airships are stationed at ground level (H0) preferentially on a platform (A1) common to several such airships (see FIGS. 1f and 1g). Depending on the organization of airships thereupon (e.g., lower configurations in the Figures), it is possible to consider energy generation during at least some of the ground period. Airships may approach platforms directly when descending, using a respective construction as marooning support (FIG. 1f), and go airborne following the reversed sequence. Alternatively, they initially land close to it and are then disposed upon it, preferentially by means of respective automatic mechanical displacement means, following its operational sequence (FIG. 1e). There could be several structures (A1, . . . ) disposed in close proximity or distributed in a given region, for example an urban area.

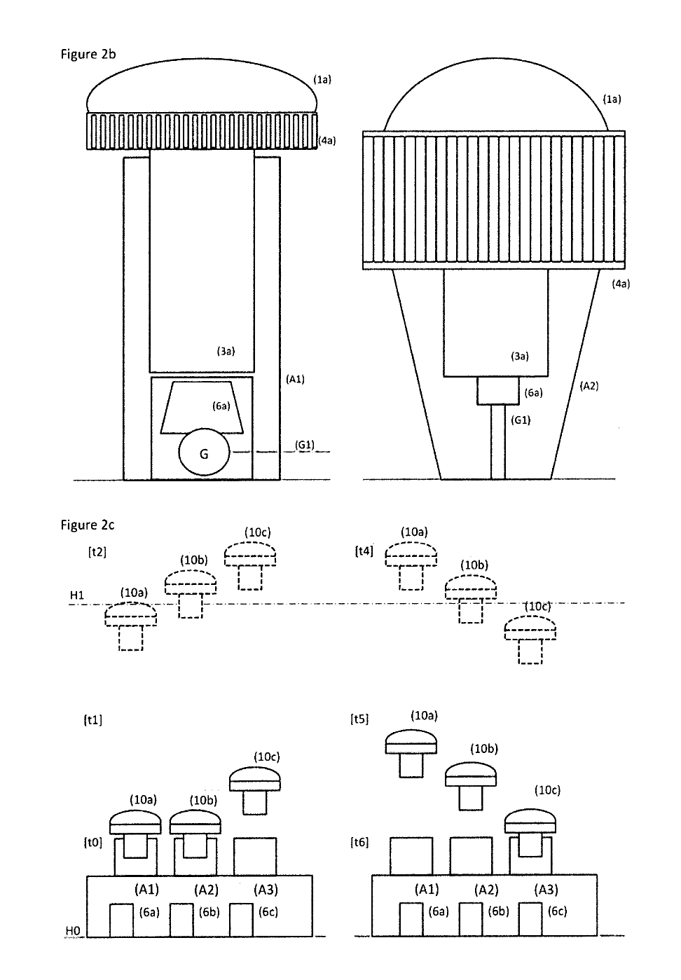

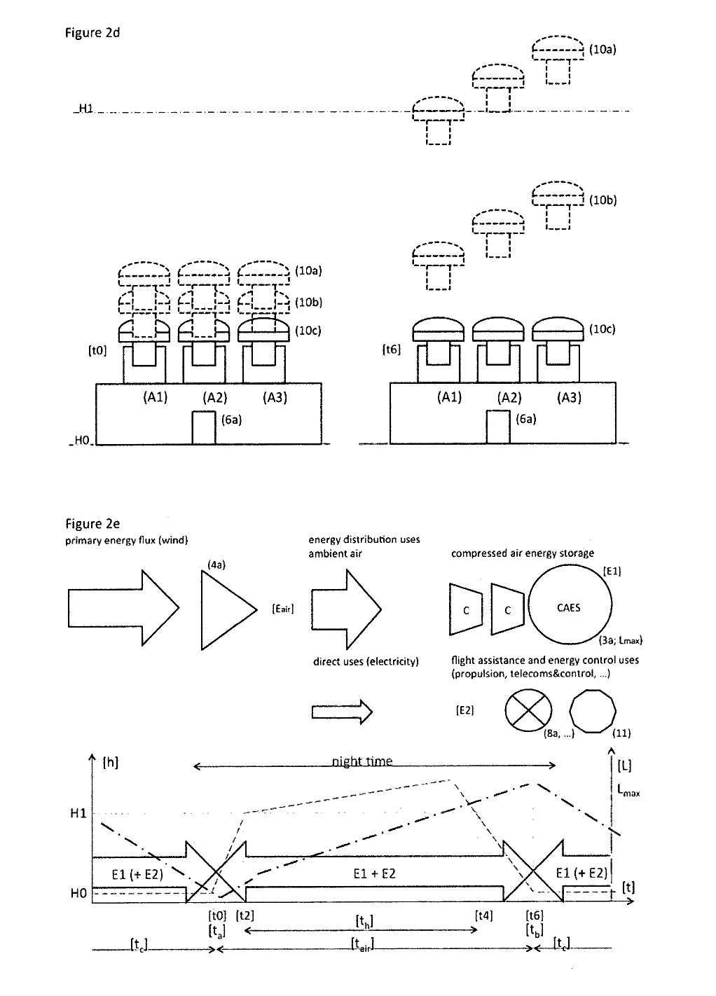

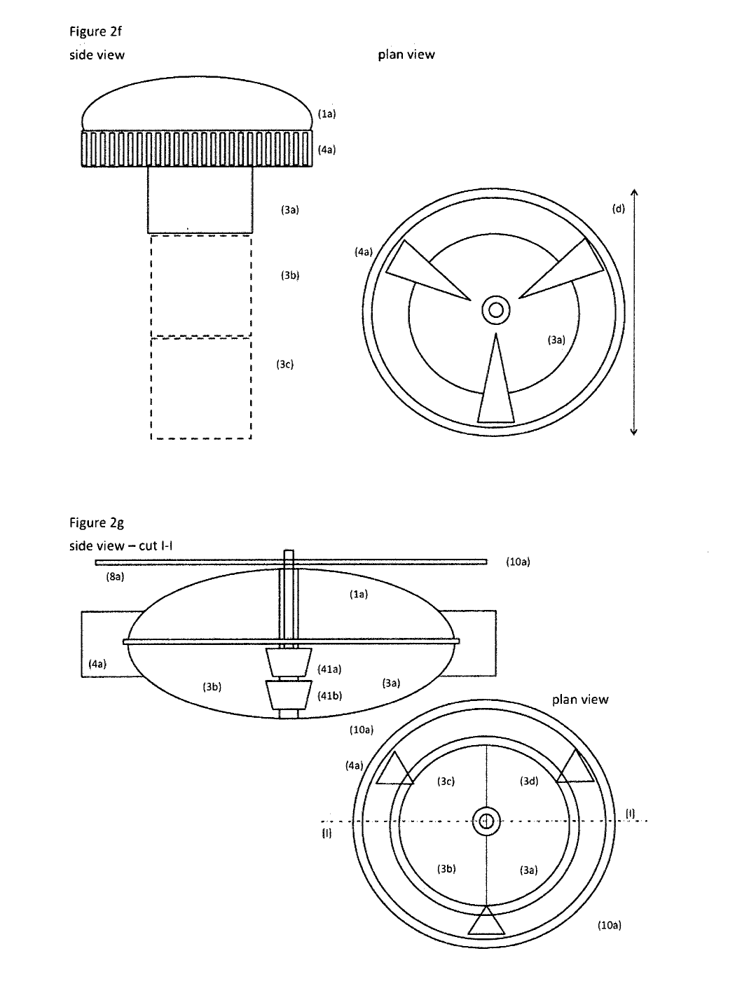

A second embodiment (see FIG. 2a) corresponds to a process whereby one airship (10a) goes airborne starting from a respective ground platform (A), ascending in instants to through t2, hovering at a given altitude range (H1) of, for example 100-2000 m, in instants t₂ through t₄ and descending back in instants t₄ through t₆, preferentially along a substantially vertical trajectory above said platform (A). Said airship (10a) at least includes (see FIG. 2b) one lift element (1a), ACU (11) and APM (8a) not represented. Moreover, it carries at least one wind energy unit WEU (4a), airborne generating a given amount of power (Eₐᵢᵣ), and one energy storage unit ESU—(3a), for storing a preferentially substantial part (E1) thereof. The ground platform (A) is preferentially designed as an elevated construction for docking of at least one respective airship (10a), thereby substantially housing and connecting at least its ESU (3a) to a respective energy conversion device or distribution network (6a). In such configuration the WEU (4a)′ preferentially also operates, though possibly at lower average wind speed, while the airship (10a) is docked at platform (A), thereby, ground generating an amount of energy (E_{grd}) that is preferentially used for either distribution (E1) or direct purposes (E2).

Alternatively, there are several airships (10a, 10b, . . . ) operating and connecting to platforms (A1, . . . ) sequentially (see FIGS. 2b and 2c), thereby delivering respective stored energy (E1) simultaneously and/or sequentially to a common conversion device or distribution network (6a). Such platforms (A1, . . . ) are preferentially disposed at a distance apart, for example as “towers” across a given low rise sub-urban area, or part of another construction, for example as “chimneys” on the roof of an industrial building.

Energy generation (see upper diagram in FIG. 2e) via the WEU (4a) preferentially extends across airborne and grounded periods, whereas power stored during airborne operation is provided during the grounded period (see FIG. 2e). A preferred operation scheme corresponds to having certain, preferentially predefined, eventually regular, periods of airborne operation. An example would be nighttime airborne and daytime ground operation. In such case, the airship (10a) goes airborne at an early evening time, generating and storing energy during nighttime especially while above a given altitude range, and returns before daylight for providing energy stored in said ESU (3a) to a respective installation (6a) during daytime. This would reduce visual interference with the airspace above urban areas.

The airship (10a) thereby generates energy (E) after going airborne, preferentially mostly via its WEU (4a) eventually also via a SEU (5a) disposed over the lift element (1a) and mostly while it hovers above a given altitude range (H1). Most of that energy (E1) is thereby used to compress air into the ESU (3a) so that this is preferentially at maximum capacity (Q) when it docks at platform (A) at., instant t″. The remanding amount (E2) is directly used to drive the propelling means (8a, . . . ), ACU (11), and increase airship lift as required.

In fact, at least part, eventually most of the energy generated by the WEU (4a) during its ascending flight may be used to drive an extensive area, surface heating element (HF) disposed next to or around the lift element (1a), thus further increasing respective lift, preferentially in a manner controlled by the ACU (11). At least starting at a given altitude, most of the mechanical energy generated by the WEU (4a) then preferentially directly drives a compressor that stores ambient air inside an onboard ESU (3a) in the form of a high-pressure air reservoir. The very low ambient temperatures prevailing at altitude especially during nighttime should assist enhanced heat dissipation leading to a substantially isothermal compression process. The ACU (11) also controls the air pressure rise in the reservoir (3a), as its additional weight brings the airship (10a) slowly back down. When the airship (10a) is docked at platform (A), the high pressure air stored in the ESU (3a) is preferentially expanded in a gas turbine or similar device, located at the platform (A), thereby driving an alternator delivering electric power. Compressed air is eventually pre-heated (using a low-grade or renewable energy heat source) and expanding cold, air is eventually/used for refrigeration or cold-sink purposes.

Overall operation is dimensioned (i.e., size and number of airships) and controlled (e.g., parallel or sequential energy offloading) with the goal of providing power during preferentially most of the daytime period, i.e. 10 16 hours, in view of actual energy conversion (e.g., prevailing wind conditions) and storage parameters (e.g., compression pressure ratio, pre-heating levels, devices being used) and. respective energy demand. Overall operation is controlled by substantially automatic means, preferentially from a ground control station, notably in view of optimizing predefined airborne schedules in view for example of short-term forecasted wind conditions.

Airships for carrying out such a process according to the invention present (see FIGS. 2f and 2g) lift (1a), ESO (3a) and WEU (4a.) elements of a preferentially substantially circular plan-section and arranged in a concentric disposition around a vertical central symmetry axis. The ESU (3a) is preferentially disposed in the lower part of the airship (10a), thereby also working as heaviest (ballast) element, The lift element (1a) is in the form of a preferentially rigid material containing a lighter than air gas, such as helium. The WEU (4a) is in the form of a vertical axis wind turbine and respective, preferentially directly mechanically driven compressor units (41a, 41b) only schematically represented in FIG. 2g. The ESU (3a) is preferentially a non-rigid cylindrical high pressure air reservoir that inflates, preferentially along predefined, folding bends, up to a maximum extension (see FIG. 2f) corresponding to a maximum, safety pressure, for example in a 100-200 bar range, or higher, thereafter deflating during the gas expansion phase, back to a low, closer to ambient pressure condition. It may also be a sequence of reservoirs (3a, 3b, 3c, 3d) collectively disposed in a spherical-like or cylindrical-like format (see FIG. 2g) , and being inflated and deflated sequentially. Such airships (.10a) may include airborne maneuvering means such as helicopter-like propellers (8a) next to the lift element (1a).

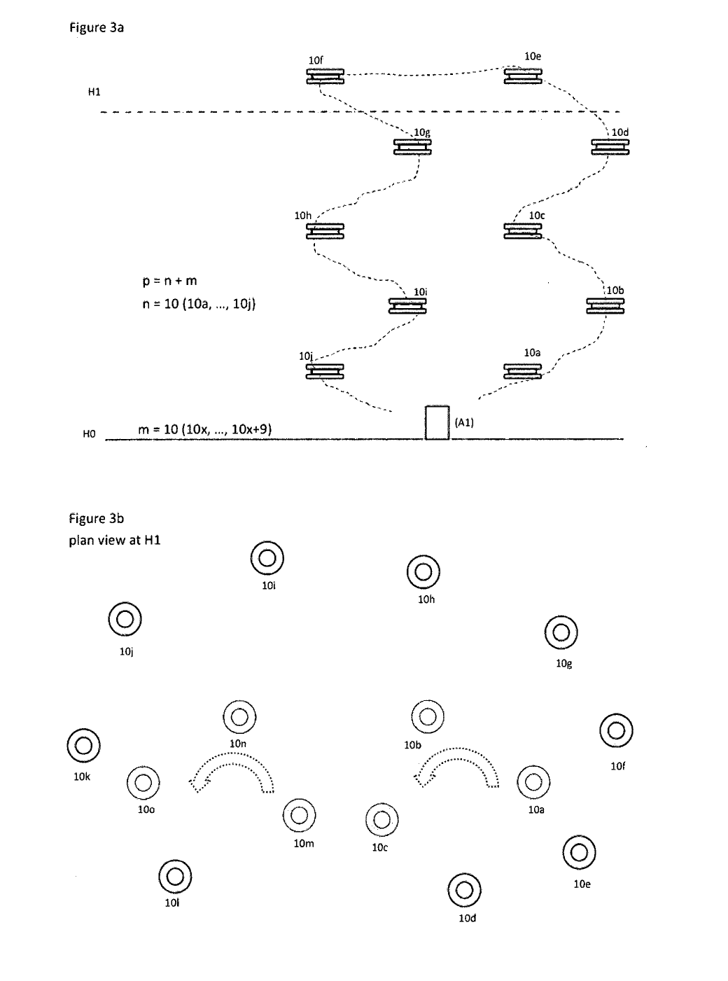

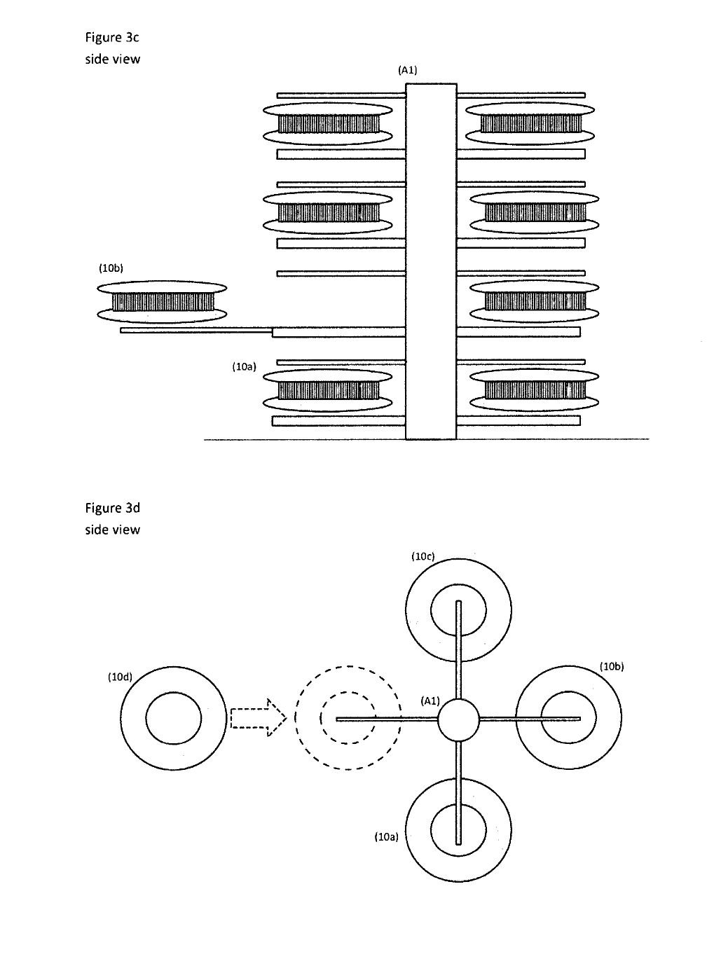

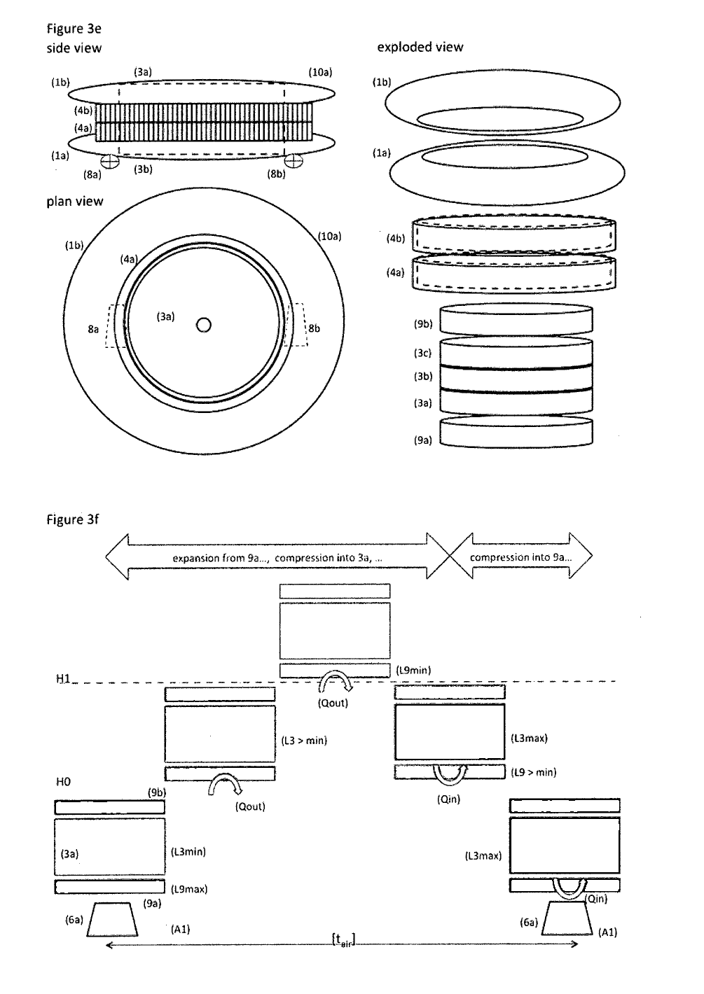

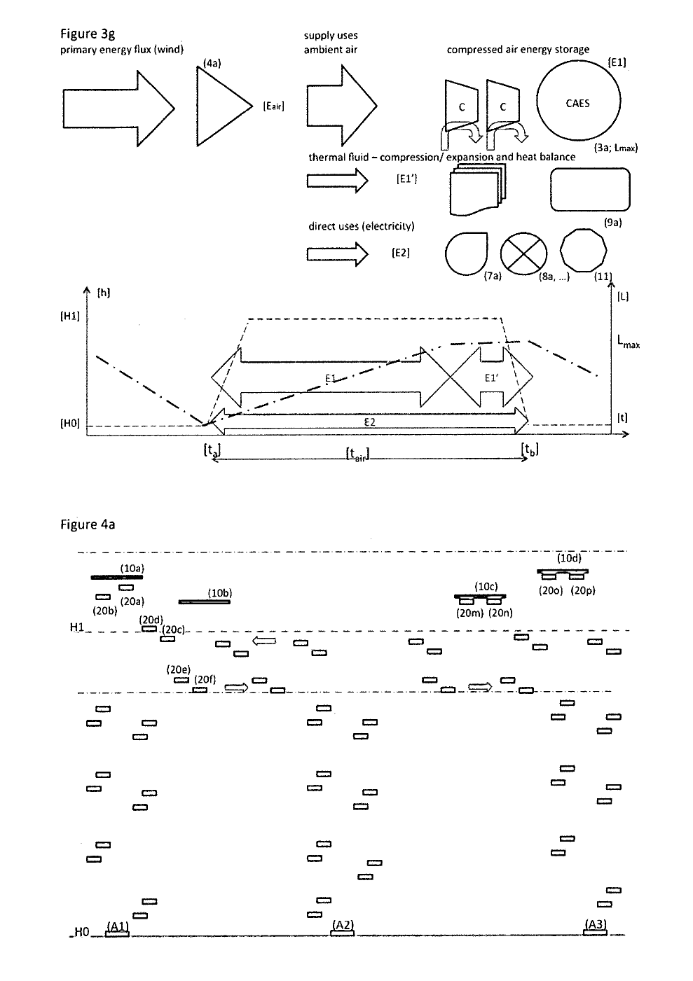

A third embodiment (see FIG. 3a) corresponds to a process including several, p=m+n, airships (10a, . . . ), whereby there are preferentially, at any moment at least several, m, such airships (10a, . . . ) operating airborne, thereby generating and storing an amount of energy m×(E1) in the form of high pressure compressed air in respective ESUs, and several, n, airships (10x, . . . ) stationed at a respective platform (A1), thereby delivering a total amount of energy n×(E1.), previously stored in respective ESUs.

All airships (10a, . . . ) preferentially operate along a substantially narrow cylindrical airspace above respective platform (A1), ascending along up-spiraling and descending along down-spiraling trajectories (see FIG. 3b), preferentially up to an altitude range (H1) of 1000-3000 m above said platform (A1). The platform (A1) (see FIGS. 3c and 3d), preferentially presents a disposition for several airships (10a, . . . ) simultaneously connecting respective ESUs (3a, . . . ) by means of a “aorta-like” connection, to common energy conversion means (e.g., compressed air turbines or combined cycle natural gas plants) available at or next to said platform (A1). Given, the lift fay the airships (10a, . . . ), the platform requires a relatively low overall structural, load bearing resistance. The possibility of substantially vertical landing and liftoff should lead to even less space requirements in comparison with conventional wind energy parks of equivalent installed capacities. Such platforms (A1, ″.) are thus preferentially located near urban areas, thereby minimizing transmission costs. Maintenance of onboard systems can be carried out during such grounded periods. After offloading the ESUs, airships (10a, . . . ) preferentially repeat the process in a substantially continuous 351×24×7 carrousel. An additional capacity, in terms of excess accumulation of fully loaded ESUs at the platform (A1), or of additional airships (10a, . . . ) going airborne, is preferentially accounted for in view of occasional longer or even no flight periods, as imposed for example by hazard weather conditions.

Each airship, (see FIG. 3e) includes two lift elements (1a, 1b) and propelling means (8a, 8b), and carries two ESU (3a, 3b) and at least two WEUs (4a, 4b) rotating in opposite directions. Airships (10a, . . . ) preferentially have very, large toroid-like lift elements (1a, 1b) disposed concentrically on both sides of very large diameter vertical axis wind turbines WEU . . . (4a, 4b) and several substantially cylindrical ESUs (3a 3b, 3c) disposed in series and presenting a high energy storage to weight ratio, thus improving overall structural stability, flight maneuverability and overall airship volume usage.

This embodiment includes a sub-process, and means for enhanced flight stability and overall energy, efficiency (see FIG. 3f). Two ballast, means (9a, 9b) are disposed on opposing sides of the ESUs (3a, 3b, 36) I All are in the form of high-pressure compressed air reservoirs, driven by a preferentially common compressing device that, is itself driven by the WEUs (4a, 4b]. At the start of airborne operation of a respective airship (10a), the ESU (3a) is at minimal load L3ₘᵢₙ″) and both ballast means (9a, 9b) are at full load (L9ₘₐₓ) and weight. The expansion of air from the ballast means is controlled with increasing altitude, notably in view of balancing the overall lift force resulting from the lower weight of the ballast means (9a, 9b), and so that the thereby released cooling power is used, preferentially by means of a wide area circulated thermal fluid, to increase heat removal efficiency from the process of air compression into the ESU (3a). The ballast means (9a, 9b) are preferentially at lowest load levels (L9ₘᵢₙ) when the ESU (3a) reaches its highest load level (L3ₘₐₓ). In a preferred process evolution, the energy provided by the WEU (4a) during the flight descending phase, is mostly used for driving the propelling means (8a) and air compression, now into the ballast means (9a, 9b). A new cycle of air compression into the ballast means (9a, 9b) starts preferentially before, and lasts preferentially as long as, the air from the ESU (3a) start being expanded in respective means (6a) disposed at a respective platform (A1).The compression heat is thereby used for pre-heating the air expanding from the ESU (3a), thus enhancing overall energy efficiency.

Operation therefore (see FIG. 3g) basically includes airborne energy generation for driving a compression process, most of which is stored (E1), in the form of a high pressure working fluid inside of a high pressure reservoir (3a), and for storing auxiliary energy (E1′) by means of compressing said working fluid, or another, inside of high pressure ballasts (9a, 9b), using thereby respectively released expansion and compression heats, preferentially by means of a thermal fluid, to reduce temperature gains (airborne compression into ESU) and temperature decreases (grounded expansion at A1) of the load cycles of the high pressure ESQ (3a). Operation then also includes energy distribution of energy stored (E1) while the airship (iOa) is at a respective platform (A1).

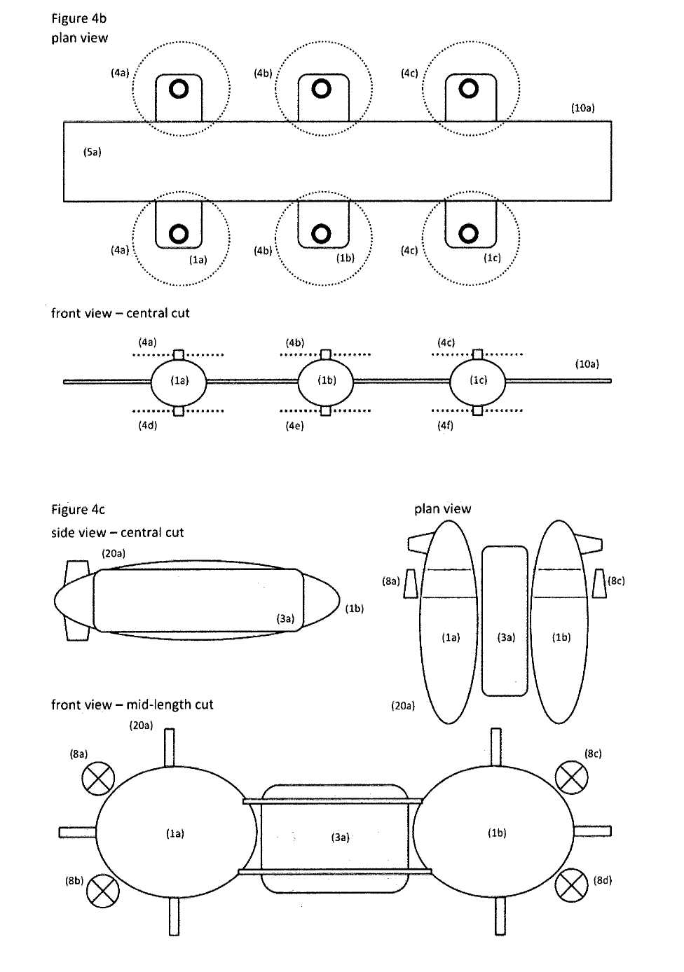

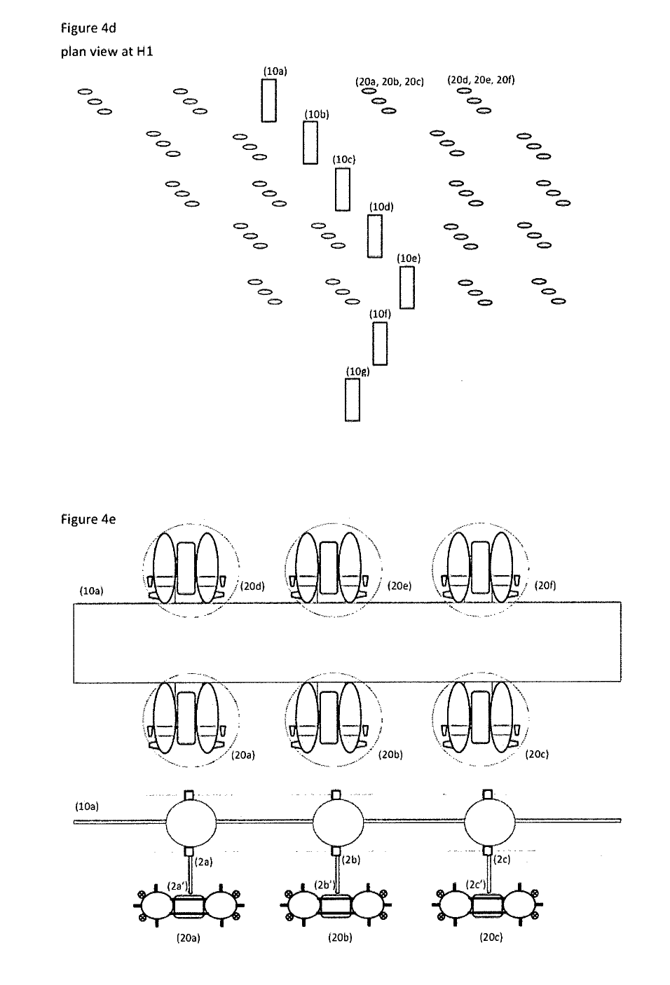

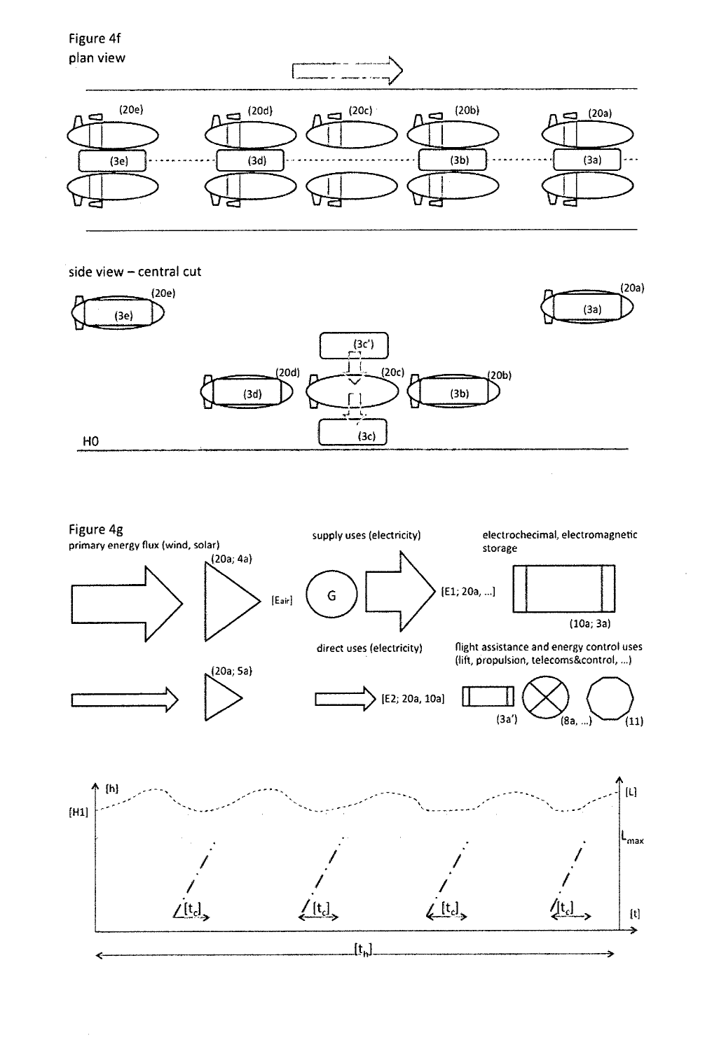

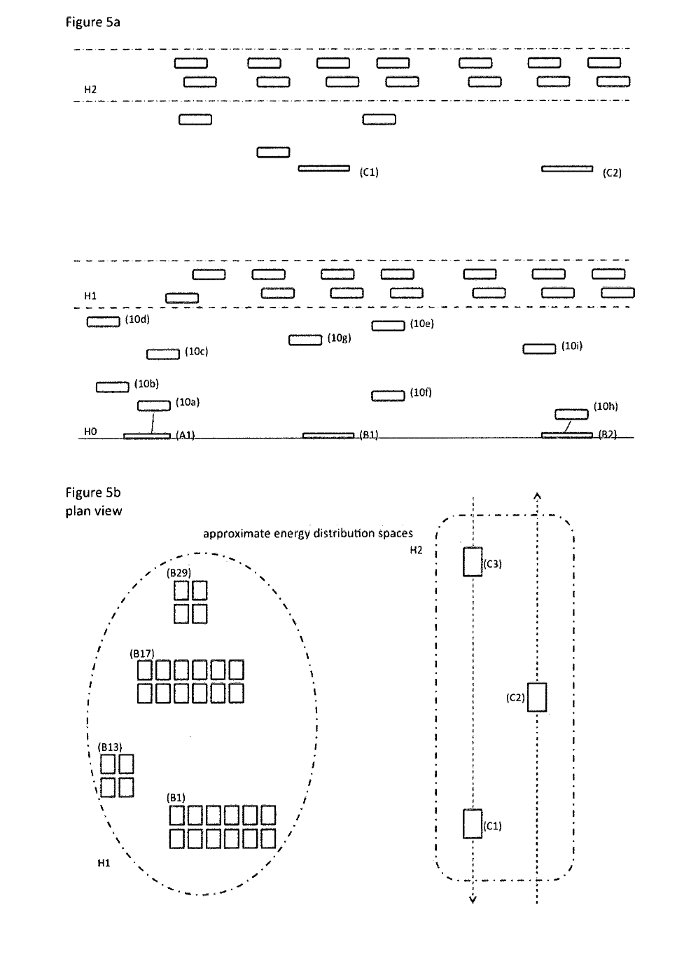

A fourth embodiment corresponds to several airships (10a, . . . ) of a given type hovering (see FIGS. 4a and 4b) for long periods at a very high altitude range (H1), for example higher than 5000 m, and several flight coordinated groups of airships (20a, . . . ), preferentially of a different type (see FIG. 4c) that sequentially and/or , simultaneously (see FIG. 4d) connect to one of such hovering airships (10a, . . . ), receive distribution energy (E1) b means of transmission, at least most of which they store on respective ESUs (3a), and shuttle between said hovering airships (10a, . . . ) and several ground platforms (A1, . . . ) in a given region for respective energy distribution. A given ESU (3a) onboard each such shuttle airship (10a, . . . ), for example in the form of a electrochemical or electromagnetic device, is electrically loaded while the latter is temporarily connected (see FIG. 4e), preferentially by means, of an electricity transmission device (between 2a and 2a′5 , such as a power conducting cable, to a respective hovering airship (10a, . . . ). Such BSUs (3c, . . . ) are then cargo offloaded (see FIG. 4f) at respective full load (Lₘₐₓ) in said platforms (A1, . . . ), and other ESU (3C) at an axe cargo loaded to respective airship (20c) before it goes airborne again.

There are two referential embodiments for cargo loading/offloading ESUs at respective ground platforms (A1, . . . ): shuttle airships (20a, . . . ) are carried along a horizontal path thereby passing along means for horizontal cargo offloading/loading of Lₘₐₓ/Lₘᵢₙ ESUs, respectively (not represented), or ESUs are vertically cargo offloaded loaded (FIG. 4f).

The ground platforms (A1, . . . ) preferentially present a disposition for several shuttle airships (20a, . . . ) simultaneously cargo offloading/loading respective ESUs (3a). Upon offloading a Lwax ESU and loading a Lₘᵢₙ ESU, shuttle airships (20a, . . . ) again go airborne. Those ESUs delivered at full load Lₘₐₓ) are then connected to a respective energy grid (G1), providing power as required until reaching Lₘᵢₙ and again made available to a shuttle airship (10a) for a new cycle.

Hovering airships (20a, . . . ) have, as depicted in FIG. 4b, three lift elements (1a, 1b, 1c) preferentially of similar dimensions and of a preferentially, substantially elongated and cylindrical form, connected by a wing-like element carrying a SEU (5a) on its upper side, and include several WEUs (4a, . . . 4n) preferentially organized in pairs disposed upon a common axis, and no ESUs. Such WEUs (4a, . . . , 4n), preferentially also work as propelling means (8a, . . . , 8n), as required. As depicted in FIG. 4c, and besides of propelling means (8a, . . . , 8d), shuttle airships (10a, . . . ) have two lift elements (1a, 1b), preferentially of similar dimensions and symmetrical forms, one ESU (3a) and respective cargo loading/offloading means.

As depicted in the energy diagram (above) in FIG. 4g, wind energy units (4a, . . . ) carried by hovering airships (10a) convert mechanical energy into electricity that is either directly provided (E1) to shuttle airships (20a), while temporarily connected, thereto, or used (E2) by propelling means (8a) and/or by other onboard flight means. PV units (5a) provide complementary energy (E2) to such systems. Part of (E2) may also be stored onboard (3′a). According to the operational diagram (below), ESUs (carried by shuttle airships) are therefore loaded, when hovering airships connect from time to time with at least one shuttle airship.

Hovering airships (20a, . . . ) at all times are provided with and/or provide substantially real time current and forecasted weather data, moving based at least thereupon to areas presenting a best trade-off between energy generation conditions and distribution distances within a predefined airspace. Shuttle airships (10a, . . . ) also provide data to remaining operating airships at least regarding respective geo-positions and overall flight conditions. Moreover, hovering (20a, . . . ) and shuttle airships (10a, . . . ) are operated according to ongoing, substantially real time and automatic supply-demand optimization analysis, geographical energy generation and distribution evaluation as relating to all platforms (A1, . . . ) in a given respective region.

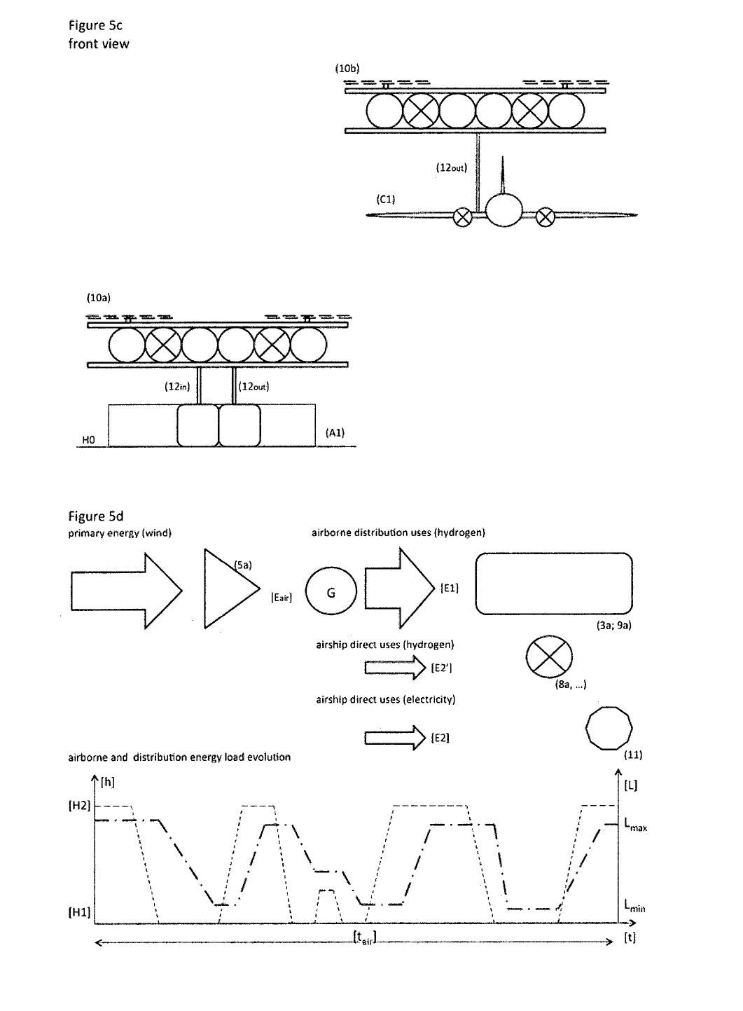

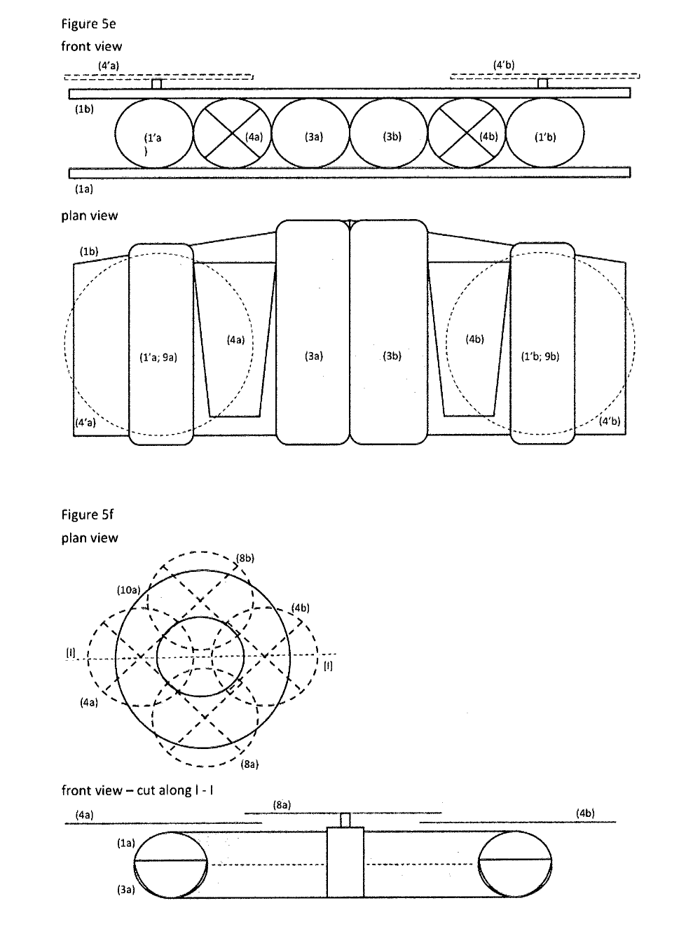

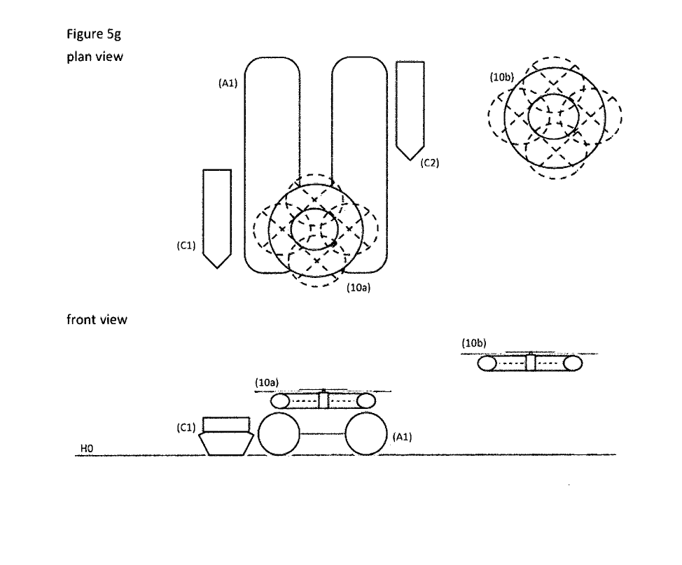

A fifth embodiment (see FIG. 5a) includes airships (10a, . . . ) airborne for long periods and thereby shuttling between two adjacent altitude ranges (H0, H1, or H1, H2), preferentially mostly hovering in airspaces (H1) above areas (see FIG. 5b) of high concentration of respective stationary consumers (B1), or above (H2) highly frequented routes of mobile energy consumers (C1). Said airships (10a, . . . ) generate energy mostly while hovering at such respective altitude ranges (H1, H2) and from time to time distribute energy (E1), preferentially as required by a given respective energy consumer (B1, C1), or a set thereof (B1, . . . ), by descending from (H1) to (H0), or descending from (H2) to (H1) (see FIG. 5c). Airships thereby maneuvering to a close proximity of said energy consumer (B1, C1) for the purpose of airborne provision, without thereby marooning to a respective platform, of a fraction, not necessarily the totality (Lₘₐₓ), of respective ESU (3a), to at least one of said consumers (B1, C1).

As depicted in respective energy diagram (see FIG. 5d, above), airships airborne process a working fluid initially stored onboard, preferentially in high pressure reservoirs working as ballast means (9a, . . . ), by means of using airborne generated energy (E1), in the form of electricity, or thermal energy, thereby obtaining an amount of fluid fuel that can be used for driving a respective energy system and that is initially stored in respective ESDs (3a). Airships (10a) may thereby upload (see FIG. 5c, below) such working fluid from a respective platform (A1), or from an open surface thereof, storing it in respective high-pressure reservoir.

Such working fluid is preferentially water, initially uploaded in the liquid state, e.g. while airship low altitude hovering over the sea surface, and/or in the vapor state, e.g. within certain cloud formations. Such water may be stored in respective preferentially high-pressure reservoirs, working as ballasts (9a). The energy generated by respective EU (4a, ″.) is used for airborne production of hydrogen that is stored in a respective ESU (3a, . . . ) until being supplied by means of a preferentially high pressure fluid connection to a respective consumer, be it a stationary (B1), such as a fueling installation, or a mobile consumer (C1), such as a ship or an airplane. Alternative working fluids could be carbon dioxide and others that may be converted into a fuel by means of an energy-driven process.

During periods of no demand, whereby ESU (3a) are already at full load Lₘₐₓ), airborne generated energy (E) is directly used, by airships (10a) for respective lift (1a), propelling (8a) and ballast means (9a), as required in view of respective operations.

These airships (10a, . . . ) may present different formats and include vertical or horizontal wind energy units (4a, . . . ), eventually also operating as propellers (see FIGS. 5e and 5f). A particular aspect relert.es to the possibility of using lift elements (1a, 1b) in the form of wings (see FIG. 5e). In this arrangement the longitudinal storage elements may initially store compressed hydrogen, thereby working as auxiliary lift elements (11′a, 1′b), and then liquid water thereby working as ballast means (9a, 9b), and be substantially empty after respective processing and storage of the resulting hydrogen in the energy storage units (3a, 3b) itself assisting overall lift of the airship.

Another particular aspect relates to the possibility of using variable volume high pressure reservoirs within a common, preferentially rigid airship body (see FIG. 5f), whereby the lower one would preferentially be used for the working fluid (temporarily functioning as ballast), and the upper one would be used for storing the fluid fuel (eventually temporarily assisting overall lift) resulting front a respective conversion process.

A seaborne platform (A1) having a substantial fluid storage capacity—for example in the form of a catamaran-like double liquid container vessel—may be used (see FIG. 5g) to receive a respective fluid fuel from airships (10a, . . . ) and to deliver it to respective energy consumers, such as ships (C1). Airships (10a, . . . ) may distribute airborne generated energy (E1), for example in the form of hydrogen, to these seaborne platforms (A1, . . . ) that basically store it in respective containers and distribute it further to consumers (C1). Alternatively, airships (10a) provide the energy, for example in the form of compressed fluid energy or electricity, required to drive the energy conversion processes, for example water electrolysis, or other conversion processes, for example water desalination, taking place at such platforms (A1).

1-17. (canceled)

18. A method for airborne energy generation and distribution, including at least one airship having a lift element, at least one renewable energy device, and at least one of an energy transmission unit, said at least one airship carrying out at least one cycle of operations, comprising:
flying a trajectory from an initial altitude to at least one destination altitude and back to the initial altitude; and
generating an amount of energy via the at least one renewable energy device;
distributing a portion of the amount of energy via the at least one energy transmission unit to an energy consumer.

19. The method of claim 18, where the at least one cycle of operation starts when a first airship leaves from a platform and ends when the first airship returns to the platform.

20. The method of claim 18, where said at least one airship generates a majority of the amount of energy at the destination altitude.

21. The method of claim 18, where for a portion of the cycle of operation, a plurality of airships is generating and distributing energy at multiple altitudes.

22. The method of claim 18, where said at least one airship distributes a majority of the amount of energy while at the destination altitude.

23. The method of claim 18, where the at least one airship distributes energy while connected to another airship.

24. The method of claim 18, where the at least one airship distributes energy while stationed at a platform.

25. The method of claim 18, where the trajectory is determined by prevailing flight conditions.

26. The method of claim 18, where there is a plurality of airships, and the trajectory of the plurality of airships is determined by minimizing a volume of airspace required by the airships within a given region.

27. The method of claim 18, where there is a plurality of airships, and each airship coordinates respective cycles of operation with another airship by sharing at least one of respective geo-positions, weather conditions, and flight conditions at respective locations.

28. The method of claim 18, where the distribution energy by the distribution energy transmission unit includes establishing an electric connection with a respective energy receiver unit.

29. The method of claim 18, where the distribution energy by the distribution energy transmission unit includes establishing an electromagnetic connection with a respective energy receiver unit.

30. The method of claim 18, where airborne energy generation and distribution includes uploading a primary energy material to the airship while airborne, and storing the primary energy material into an energy storage unit.

31. The method of claim 18, where the platform comprises a mobile vehicle.

32. A method for airborne energy generation and storage, including at least one airship having a lift element, a renewable energy device, and at least one of an energy storage unit, said at least one airship carrying out at least one cycle of operations, comprising:
flying a trajectory from an initial altitude to at least one destination altitude and back to the initial altitude; and
generating an amount of energy via the at least one renewable energy device;
storing a portion of the amount of energy to the at least one energy storage unit.

33. The method of claim 32, where the energy storage unit is connected to an energy conversion unit and an energy distribution unit.

34. The method of claim 33, where the connection between the energy storage unit and the energy conversion unit includes a high pressure fluid connection.
